(19) United States
(12) Patent Application Publication
(10) Pub. No.: US 2024/0188086 A1
(43) Pub. Date: Jun. 6, 2024

(54) RESOURCE MAPPING METHOD AND COMMUNICATION DEVICE FOR UPLINK CONTROL INFORMATION (UCI)

(71) Applicant: Beijing Xiaomi Mobile Software Co., Ltd., Beijing (CN)

(72) Inventor: Yuanyuan LI, Beijing (CN)

(73) Assignee: Beijing Xiaomi Mobile Software Co., Ltd., Beijing (CN)

(21) Appl. No.: 18/550,796

(22) PCT Filed: Mar. 22, 2021
(86) PCT No.: PCT/CN2021/082185

§ 371 Date: Sep. 15, 2023

(51) Int. Cl. H04W 72/21; H04L 5/00

(52) U.S. Cl. CPC H04W 72/21; H04L 5/0051

(57) ABSTRACT

The present application provides a resource mapping method and communication device for uplink control information (UCI). The resource mapping method for UCI is performed by a terminal device, and can include determining that a Physical Uplink Control Channel (PUCCH) overlaps with a Physical Uplink Shared Channel (PUSCH) and that no Demodulation Reference Signal (DMRS) is borne by a current first PUSCH, performing resource mapping on the UCI according to a target resource mapping mode of the UCI, wherein the target resource mapping mode is configured to map the UCI to a PUSCH resource, and sending the UCI to a network device through the mapped resource.

### CROSS-REFERENCE TO RELATED APPLICATION

The present disclosure is the U.S. National phase application of International Application No. PCT/CN2021/082185, filed on Mar. 22, 2021, the entire content of which is incorporated herein by reference for all purposes.

### BACKGROUND

### Technical Field

The present disclosure relates to the field of communication technology and, in particular, to a resource mapping method and communication device for Uplink Control Information (UCI).

### Description of the Related Art

In the related technology, the higher the operating frequency of the cellular network, the greater the path loss of the wireless channel of the cellular network. In order to improve the uplink coverage of the New Radio (NR), the data transmission is generally improved by reducing the density of the demodulation reference signals. When the Physical Uplink Control Channel (PUCCH) overlaps with the Physical Uplink Shared Channel (PUSCH) in the communication process, the Demodulation Reference Signal (DMRS) is required to assist in the mapping of the Uplink Control Information (UCI) for transmission in the PUSCH. However, there is no mature solution for the related technology in the absence of DRMS in the PUSCH.

### SUMMARY

According to embodiments of the present disclosure, a resource mapping method and communication device for UCI is provided.

In a first aspect, a resource mapping method for UCI is provided by an embodiment of the present disclosure, which is applied to a terminal device. The method includes: determining, by the terminal device, that a PUCCH overlaps with a PUSCH and that no DMRS is borne by a current first PUSCH; performing, by the terminal device, resource mapping on the UCI according to a target resource mapping mode of the UCI, and sending the UCI to a network device through a mapped resource; wherein the target resource mapping mode is configured to map the UCI to a PUSCH resource.

In a second aspect, a resource mapping method for UCI is provided by an embodiment of the present disclosure, which is performed by a network device. The method includes:
receiving, by the network device, the UCI sent on a mapped resource by a terminal device, wherein a PUCCH overlaps with a PUSCH, no DMRS is borne by a current first PUSCH, and the UCI is mapped to a PUSCH resource according to a target resource mapping mode.

In a third aspect, a communication device is provided by an embodiment of the present disclosure, which has some or all of the functions of the terminal device for implementing the method described in the first aspect above. For example, the functions of the communication device may have the functions in some or all embodiments of the present disclosure, or may have the functions for separately implementing any one of the embodiments of the present disclosure. These functions may be realized by hardware or by hardware executing corresponding software. The hardware or software includes one or more units or modules corresponding to these functions.

In one implementation, the communication device may include a transceiver module and a processing module. The processing module is configured to support the communication device in performing the corresponding functions in the method described above. The transceiver module is configured to support communication between the communication device and other devices. The communication device may further include a storage module for coupling with the transceiver module and the processing module, which stores the necessary computer programs and data of the communication device.

For example, the processing module may be a processor, the transceiver module may be a transceiver or a communication interface, and the storage module may be a memory.

In a fourth aspect, a communication device is provided by an embodiment of the present disclosure, which has some or all of the functions of the network device for implementing the method described in the second aspect above. For example, the functions of the communication device may have the functions in some or all embodiments of the present disclosure, or may have the functions for separately implementing any one of the embodiments of the present disclosure. These functions may be realized by hardware or by hardware executing corresponding software. The hardware or software includes one or more units or modules corresponding to these functions.

In one implementation, the communication device may include a transceiver module and a processing module. The processing module is configured to support the communication device in performing the corresponding functions in the method described above. The transceiver module is configured to support communication between the communication device and other devices. The communication device may further include a storage module for coupling with the transceiver module and the processing module, which stores the necessary computer programs and data of the communication device.

For example, the processing module may be a processor, the transceiver module may be a transceiver or a communication interface, and the storage module may be a memory.

In a fifth aspect, a communication device is provided by an embodiment of the present disclosure, which includes a processor that performs the method described in the first aspect above when the processor calls a computer program in memory.

In a sixth aspect, a communication device is provided by an embodiment of the present disclosure, which includes a processor that performs the method described in the second aspect above when the processor calls a computer program in memory.

In a seventh aspect, a communication device is provided by an embodiment of the present disclosure, which includes a processor and a memory, the memory having a computer program stored therein, the processor executing the computer program stored in the memory to cause the device to perform the method described in the first aspect.

In an eight aspect, a communication device is provided by an embodiment of the present disclosure, which includes a processor and a memory, the memory having a computer program stored therein, the processor executing the computer program stored in the memory to cause the device to perform the method described in the second aspect.

In a ninth aspect, a communication device is provided by an embodiment of the present disclosure, which includes a processor and an interface circuit. The interface circuit is configured to receive code instructions and transmit the code instructions to the processor. The processor is configured to run the code instructions to perform the method described in the first aspect above.

In a tenth aspect, a communication device is provided by the present disclosure, which includes: a processor and an interface circuit. The interface circuit is configured to receive code instructions and transmit the code instructions to the processor. The processor is configured to run the code instructions to perform the method described in the second aspect above.

In an eleventh aspect, a communication system is provided by an embodiment of the present disclosure, which includes the communication device described in the third aspect and the communication device described in the fourth aspect, or, alternatively, the communication device described in the fifth aspect and the communication device described in the sixth aspect, or, alternatively, the communication device described in the seventh aspect and the communication device described in the eighth aspect, or, alternatively, the communication device described in the ninth aspect and the communication device described in the tenth aspect.

In a twelfth aspect, a non-transitory computer-readable storage medium is provided by an embodiment of the present disclosure, which is configured to store instructions that, when executed, cause the method described in the first aspect above to be implemented.

In a thirteenth aspect, a non-transitory computer-readable storage medium is provided by an embodiment of the present disclosure, which is configured to store instructions that, when executed, cause the method described in the second aspect above to be implemented.

In a fourteenth aspect, the present disclosure further provides a computer program product including a computer program which, when run on a computer, causes the computer to perform the method described in the first aspect above.

In a fifteenth aspect, the present disclosure further provides a computer program product including a computer program which, when run on a computer, causes the computer to perform the method described in the second aspect above.

In a sixteenth aspect, the present disclosure provides a chip system including at least one processor and an interface for supporting a terminal device in implementing the functions involved in the first aspect, for example, determining or processing at least one of the data and information involved in above method. In one possible design, the chip system further includes a memory for storing the necessary computer programs and data of the terminal device. The chip system may include a chip or may include a chip and other discrete devices.

In a seventeenth aspect, the present disclosure provides a chip system including at least one processor and an interface for supporting a network device in implementing the functions involved in the second aspect, for example, determining or processing at least one of the data and information involved in above method. In one possible design, the chip system further includes a memory for storing the necessary computer programs and data of the terminal device. The chip system may include a chip or may include a chip and other discrete devices.

In an eighteenth aspect, the present disclosure provides a computer program which, when run on a computer, causes the computer to perform the method described in the first aspect above.

In a nineteenth aspect, the present disclosure provides a computer program which, when run on a computer, causes the computer to perform the method described in the second aspect above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of architecture of a communication system provided by an embodiment of the present disclosure.

FIG. 2 is a flowchart of a resource mapping method for UCI according to an embodiment of the present disclosure.

FIG. 3 is a flowchart of a resource mapping method for UCI according to another embodiment of the present disclosure.

FIG. 4 is a flowchart of a resource mapping method for UCI according to yet another embodiment of the present disclosure.

FIG. 5 is a flowchart of a resource mapping method for UCI according to still another embodiment of the present disclosure.

FIG. 6 is a flowchart of a resource mapping method for UCI according to still another embodiment of the present disclosure.

FIG. 7 is a flowchart of a resource mapping method for UCI according to still another embodiment of the present disclosure.

FIG. 8 is a flowchart of a resource mapping method for UCI according to still another embodiment of the present disclosure.

FIG. 9 is a schematic diagram of a structure of a communication device according to an embodiment of the present disclosure.

FIG. 10 is a schematic diagram of a structure of a communication device according to an embodiment of the present disclosure.

FIG. 11 is a schematic diagram of a structure of a chip according to an embodiment of the present disclosure.

### DETAILED DESCRIPTION OF THE PREFERRED EMBODIMENTS

Referring now to the drawings, wherein like reference numerals designate identical or corresponding parts throughout the several views.

Embodiments of the present disclosure will be described in detail below; examples of which are shown in the accompanying drawings, wherein the same or similar numerals throughout denote the same or similar elements or elements having the same or similar functions. The embodiments described below by reference to the accompanying drawings are exemplary and are intended to be used to explain the present disclosure and are not to be construed as limitations of the present disclosure.

For ease of understanding, the terminology involved in the present disclosure is first introduced.

### 1. Uplink Control Information (UCI)

The UCI contains information related to the current state of the terminal device, such as whether the terminal device currently needs to request uplink resources, the quality of the downlink currently detected by the terminal device, and the number of transmission layers that the terminal device can distinguish.

### 2. Physical Uplink Control Channel (PUCCH)

The PUCCH is used for the terminal device to send information related to uplink scheduling to the base station, such as scheduling requests, channel status information, etc.

### 3. Physical Uplink Shared Channel (PUSCH)

The PUSCH is used to bear uplink services and upper layer signaling data related to long-term evolution users, which serves as the main uplink data bearer channel in the physical layer, and can be used to schedule the transmission of uplink data and also bear control information.

### 4. Demodulation Reference Signal (DMRS)

The DMRS is used in communication technology for related demodulation of PUSCH and PUCCH channels.

### 5. Hybrid Automatic Repeat reQuest Acknowledgement (HARQ-ACK)

HARQ is a combination of Forward Error Correction (FEC) and Automatic Repeat-reQuest (ARQ), so that it is called Hybrid Automatic Repeat reQuest. HARQ-ACK is an answer or feedback to a HARQ.

### 6. Channel State Information (CSI)

In the field of wireless communications, the so-called CSI is the channel property of a communication link. It describes the fading factor of the signal on each transmission path, i.e., the value of each element in the channel gain matrix H, such as signal scattering, environmental fading (fading, multipath fading or shadowing fading), power decay of distance, and other information. CSI enables the communication system to adapt to the current channel conditions and provides a guarantee for high reliability and high speed communication in multi-antenna systems.

In order to better understand the resource mapping method for UCI provided by embodiments of the present disclosure, the communication system used in the embodiments of the present disclosure is first described below.

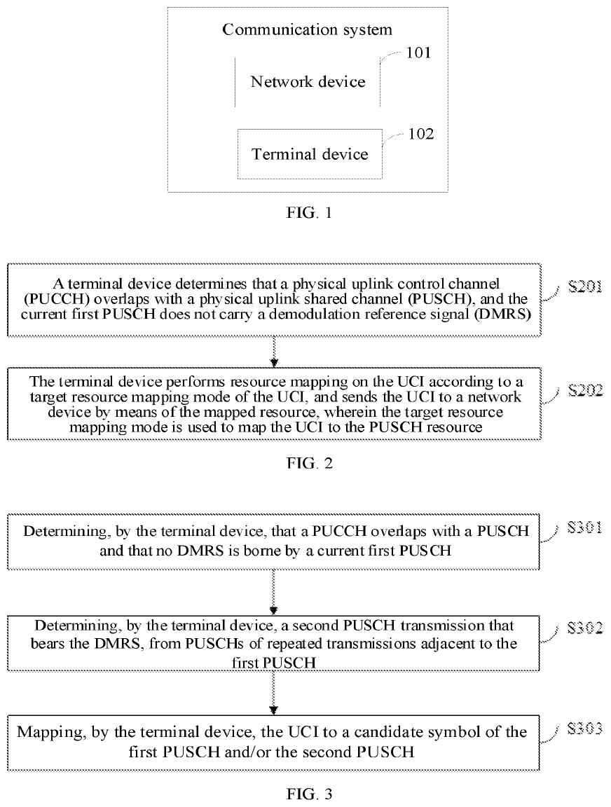

As shown in FIG. 1, FIG. 1 is a schematic diagram of architecture of a communication system provided in an embodiment of the present disclosure. The communication system may include, but is not limited to, a network device and a terminal device. The number and form of the devices shown in FIG. 1 are for example only and do not constitute a limitation of the embodiments of the present disclosure, and may include two or more network devices, and two or more terminal devices, in practical applications. The communication system shown in FIG. 1 is exemplified by including a network device 101 and a terminal device 102.

It should be noted that the technical solutions of the embodiments of the present disclosure can be applied to various communication systems. For example, a long term evolution (LTE) system, a 5th generation (5G) mobile communication system, a 5G new radio (NR) system, or other future new mobile communication systems.

The network device 101 in the embodiments of the present disclosure is an entity on the network side for transmitting or receiving signals. For example, the network device 101 may be an evolved NodeB (eNB), a transmission reception point (TRP), a next generation NodeB (gNB) in a NR system, a base station in other future mobile communication systems, or an access node in a wireless fidelity (Wi-Fi) system, etc. The specific technology and the specific device form used for the network device are not limited in the embodiments of the present disclosure. The network device provided by the embodiments of the present disclosure may be composed of a centralized unit (CU) and a distributed unit (DU), wherein the CU may also be referred to as a control unit. The CU-DU structure may be used to separate the protocol layer of the network device, such as the base station, with part of the functions of the protocol layer under centralized control in the CU, and some or all of the remaining functions of the protocol layer distributed in the DU controlled centrally by the CU.

The terminal device 102 in the embodiments of the present disclosure is an entity on the user side for receiving or transmitting signals, such as a cellular phone. The terminal device may also be referred to as a terminal, user equipment (UE), mobile station (MS), mobile terminal (MT), and the like. The terminal may be a car with communication functions, a smart car, a mobile phone, a wearable device, a tablet computer (Pad), a computer with wireless transceiver functions, a virtual reality (VR) terminal, a augmented reality (AR) terminal, a wireless terminal in an industrial control environment, a wireless terminal in a self-driving environment, a wireless terminal in remote medical surgery, a wireless terminal in the smart grid, a wireless terminal in the transportation safety, a wireless terminal device in the smart city, a wireless terminal in the smart home, and so on. The specific technologies and specific equipment forms adopted for the terminal device are not limited by the embodiments of the present disclosure.

It should be understood that the communication system described in the embodiments of the present disclosure is intended to more clearly illustrate the technical solutions of the embodiments of the present disclosure, and does not constitute a limitation on the technical solutions proposed in the embodiments of the present disclosure, and a person of ordinary skill in the art may know that, with the evolution of the system architecture and the emergence of new business scenarios, the technical solutions proposed in the embodiments of the present disclosure are equally applicable to similar technical problems.

A resource mapping method and apparatus for uplink control information (UCI) provided in the present disclosure are described in detail below in conjunction with the accompanying drawings.

FIG. 2 is a flowchart of a resource mapping method for UCI according to an embodiment of the present disclosure. This method is applied to a terminal device, as shown in FIG. 2, the method including the following steps.

S201, determining, by the terminal device, that a Physical Uplink Control Channel (PUCCH) overlaps with a Physical Uplink Shared Channel (PUSCH) and that no Demodulation Reference Signal (DMRS) is borne by a current first PUSCH.

The terminal device transmits uplink information or data with the network device through the physical uplink channel. The physical uplink channel includes the Physical Uplink Control Channel (PUCCH) and the Physical Uplink Shared Channel (PUSCH). In an implementation, the uplink information may be the Uplink Control Information (UCI), which can be borne by the terminal device in the PUCCH or in the PUSCH for transmission.

Optionally, the UCI information may include Hybrid Automatic Repeat reQuest Acknowledgement (HARQ-ACK) information and/or Channel State Information (CSI).

When transmitting the UCI in the PUCCH, the same terminal device in the same uplink subframe cannot transmit information in both the PUCCH and the PUSCH channels at the same time. In related art, for the PUCCH and the PUSCHs that adopt multiple time slots for repeated transmissions, there may be an overlap between the PUCCH and a PUSCH, and when a Demodulation Reference Signal (DMRS) is borne by the PUSCH, the UCI can be mapped to be transmitted over the PUSCH which overlaps with the PUCCH. However, in the scenario where it is determined that the PUCCH and the PUSCH overlap and there is no DMRS borne by the PUSCH, no resource mapping scheme for UCI is provided in related art. Therefore, in the embodiments of the present disclosure, for the scenario where there exists a PUSCH that overlaps with the PUCCH and there is no DMRS borne by the PUSCH, the following resource mapping scheme for UCI is proposed.

In some embodiments of the present disclosure, the terminal device first detects the current channel state, and if the current channel state indicates that the PUCCH and the PUSCH overlap and no DMRS is borne by the current first PUSCH, the terminal device may perform step S202.

Optionally, if the PUCCH does not overlap with the PUSCH and/or if the DMRS is borne on the current first PUSCH, the UCI may be transmitted on the PUSCH that overlaps with the PUCCH. For example, when the resource mapping is performed on the UCI for transmission on the PUSCH, the UCI cannot be mapped on the symbol(s) of the PUSCH on which the DMRS is borne, and the HARQ-ACK information should be mapped on the first symbol that does not bear the DMRS after the earliest DMRS on the PUSCH, and for the CSI, the resource mapping can start from the first symbol on the PUSCH that does not bear the DMRS.

S202, performing, by the terminal device, resource mapping on the UCI according to a target resource mapping mode of the UCI, and sending the UCI to a network device through a mapped resource, wherein the target resource mapping mode is configured to map the UCI to a PUSCH resource.

After the terminal device determines that the current channel state meets the overlap between the PUCCH and the PUSCH, and that no DMRS is borne by the current first PUSCH, the terminal device, in order to realize the transmission of the UCI to the network device, needs to perform the resource mapping on the UCI according to the target resource mapping mode of the UCI. In the embodiments of the present disclosure, the target resource mapping mode is used to instruct to map the UCI to a PUSCH resource. In some implementations, the terminal device may map the UCI onto a first PUSCH resource currently transmitted. In other implementations, the terminal device may map the UCI onto a PUSCH resource that meets a condition by selecting the PUSCH that meets the condition from the repeated transmitted PUSCHs. For example, the selected PUSCH is required to meet the condition that the DMRS is borne by that PUSCH and/or the selected PUSCH is adjacent to the first PUSCH. Optionally, the terminal device, when mapping the UCI onto the PUSCH resource, may perform the resource mapping based on the information included in the UCI, in accordance with the respective requirements of the information.

In some implementations, the terminal device may be configured with one resource mapping mode or a plurality resource mapping modes. Optionally, the terminal device may determine a target resource mapping mode to be used from the plurality of resource mapping modes based on a protocol agreement or an indication from the network side.

Optionally, after completing the resource mapping of the UCI, the terminal device may send the UCI to the network device through the mapped resource.

In the resource mapping method for UCI provided by the embodiment of the present disclosure, the terminal device determines that it is currently in a scenario where the PUCCH and the PUSCH overlap and no DMRS is borne by the current first PUSCH, and according to the target resource mapping mode, the terminal device maps the UCI to the PUSCH for transmission. The present disclosure can not only realize the mapping of the UCI onto the PUSCH resource in the case of the absence of DMRS, but also increases the amount of data transmitted and reduces the bit rate of data transmission while reducing the DMRSs on transmission and reducing the density of the DMRSs, thereby improving the signal-to-noise ratio for signal reception and network coverage.

FIG. 3 is a flowchart of a resource mapping method for UCI according to another embodiment of the present disclosure. This method is applied to a terminal device, as shown in FIG. 3, the method including the following steps.

S301, determining, by the terminal device, that a PUCCH overlaps with a PUSCH and that no DMRS is borne by a current first PUSCH. The specific introduction of the step S301 can be referred to the description of the relevant contents in the above embodiments, and will not be repeated herein.

S302, determining, by the terminal device, a second PUSCH that bears the DMRS, from PUSCHs of repeated transmissions adjacent to the first PUSCH.

Optionally, the terminal device may determine a transmission moment or a transmission time slot of the first PUSCH, and may in turn be able to determine, based on the transmission moment or the transmission time slot of the first PUSCH, at least one repeatedly transmitted PUSCH that is located after the transmission moment or the transmission time slot of the first PUSCH, and based on the configuration information of the PUSCH, the terminal device may determine whether or not there is a DMRS borne on the at least one repeatedly transmitted PUSCH. As a result, the terminal device may identify a second PUSCH that bears a DMRS, from the repeated transmitted PUSCH(s) adjacent to the first PUSCH.

S303, mapping, by the terminal device, the UCI to a candidate symbol of the first PUSCH and/or the second PUSCH.

Optionally, the terminal device may determine one or more candidate symbols from the first PUSCH and/or the second PUSCH that are suitable for mapping the UCI and map the UCI to some or all of the one or more candidate symbols.

In some implementations, the target resource mapping mode may include that the terminal device may map the UCI to a candidate symbol of the first PUSCH. In other implementations, the target resource mapping mode may include that the terminal device may map a portion of the UCI to a candidate symbol of the first PUSCH and another portion of the UCI to a candidate symbol of the second PUSCH. In yet other implementations, the target resource mapping mode may include that the terminal device may map the UCI to a candidate symbol of the second PUSCH.

Optionally, the UCI includes a Hybrid Automatic Repeat reQuest Acknowledgement (HARQ-ACK) and/or Channel State Information (CSI). In a possible implementation, the target resource mapping mode may include that the terminal device maps the HARQ-ACK to a position of a first candidate symbol of the second PUSCH; and/or, the terminal device maps the CSI to a position of a second candidate symbol of the first PUSCH.

In the resource mapping method for UCI provided by the embodiment of the present disclosure, the terminal device determines that it is currently in a scenario where the PUCCH and the PUSCH overlap and no DMRS is borne on the current first PUSCH, and according to the target resource mapping mode, the terminal device maps the UCI to the PUSCH for transmission. The present disclosure can not only realize the mapping of the UCI onto the PUSCH resource in the case of the absence of DMRS, but also increases the amount of data transmitted and reduces the bit rate of data transmission while reducing the DMRSs on transmission and reducing the density of the DMRSs, thereby improving the signal-to-noise ratio for signal reception and network coverage.

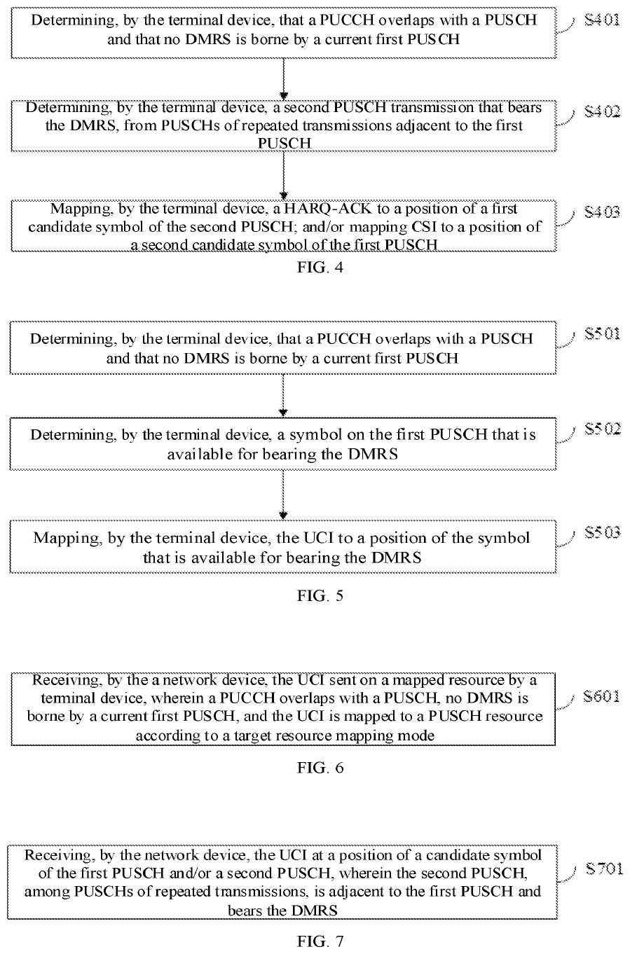

FIG. 4 is a flowchart of a resource mapping method for UCI according to yet another embodiment of the present disclosure. This method is applied to a terminal device, as shown in FIG. 4, the method including the following steps.

S401, determining, by the terminal device, that a PUCCH overlaps with a PUSCH and that no DMRS is borne by a current first PUSCH.

S402, determining, by the terminal device, a second PUSCH that bears the DMRS, from PUSCHs of repeated transmissions adjacent to the first PUSCH.

The specific introduction of the steps S401-402 can be referred to the description of the relevant contents in the above embodiments, and will not be repeated herein.

S403, mapping, by the terminal device, a HARQ-ACK to a position of a first candidate symbol of the second PUSCH; and/or mapping CSI to a position of a second candidate symbol of the first PUSCH.

Optionally, the target resource mapping mode may include that the terminal device may determine the first one symbol on the second PUSCH that does not bear the DMRS after a target symbol, as the first candidate symbol of the second PUSCH, the target symbol being the earliest one that bears the DMRS, and the terminal device may map the HARQ-ACK to the position of the first candidate symbol. That is, the terminal device may map the HARQ-ACK to the first one symbol that does not bear DMRS after the earliest DMRS-bearing target symbol on the second PUSCH.

Optionally, the terminal device may determine the first one symbol on the first PUSCH or a symbol on the first PUSCH that is available for bearing the DMRS, as the second candidate symbol of the first PUSCH. The terminal device may map the CSI to the position of the second candidate symbol by mapping the CSI to the position of the symbol on the first PUSCH that is available for bearing the DMRS. In another example, the terminal device may map the CSI to the position of the first one symbol on the first PUSCH.

That is, the target resource mapping mode may include that the terminal device maps the HARQ-ACK to the first one symbol that does not bear the DMRS after the earliest DMRS-bearing target symbol on the second PUSCH, and/or the terminal device maps the CSI to a position of a symbol on the first PUSCH that is available for bearing the DMRS.

The target resource mapping mode may include that the terminal device maps the HARQ-ACK to the first one symbol that does not bear the DMRS after the earliest DMRS-bearing target symbol on the second PUSCH, and/or the terminal device maps the CSI to a position of the first one symbol on the first PUSCH.

In the resource mapping method for UCI provided by the embodiment of the present disclosure, the terminal device determines that it is currently in a communication scenario where the PUCCH and the PUSCH overlap and no DMRS is borne on the current first PUSCH, and according to the target resource mapping mode, the terminal device maps the UCI to the PUSCH for transmission, which increases the amount of data transmitted and reduces the bit rate of data transmission while reducing the DMRSs on transmission and reducing the density of the DMRSs, thereby improving the signal-to-noise ratio for signal reception and network coverage.

FIG. 5 is a flowchart of a resource mapping method for UCI according to still another embodiment of the present disclosure. This method is applied to a terminal device, as shown in FIG. 5, the method including the following steps.

S501, determining, by the terminal device, that a PUCCH overlaps with a PUSCH and that no DMRS is borne by a current first PUSCH. The specific introduction of the step S501 can be referred to the description of the relevant contents in the above embodiments, and will not be repeated herein.

S502, determining, by the terminal device, a symbol on the first PUSCH that is available for bearing the DMRS.

S503, mapping, by the terminal device, the UCI to a position of the symbol that is available for bearing the DMRS.

Here, the UCI includes a HARQ-ACK and/or CSI.

The terminal device may determine a symbol that can be used to bear the DMRS based on the configuration information of the symbols on the first PUSCH. Further, the terminal device may take the symbol that can be used to bear the DMRS as a candidate symbol, and map the UCI to a position of the candidate symbol on the first PUSCH, i.e., mapping the UCI to a position of the symbol that is available for bearing the DMRS on the first PUSCH.

Optionally, in response to the UCI including a HARQ-ACK, the HARQ-ACK is mapped to the first PUSCH for transmission; in response to the UCI including a HARQ-ACK and CSI, both the HARQ-ACK and the CSI may be mapped to the first PUSCH for transmission; in response to the UCI including CSI, the CSI may be mapped to the first PUSCH for transmission.

That is, the target resource mapping mode may include that the terminal device maps the HARQ-ACK and/or the CSI to the position of the symbol on the first PUSCH that is available for bearing the DMRS.

In the resource mapping method for UCI provided by the embodiment of the present disclosure, the terminal device determines that it is currently in a scenario where the PUCCH and the PUSCH overlap and no DMRS is borne on the current first PUSCH, and according to the target resource mapping mode, the terminal device maps the UCI to the PUSCH for transmission. The present disclosure can not only realize the mapping of the UCI onto the PUSCH resource in the case of the absence of DMRS, but also increases the amount of data transmitted and reduces the bit rate of data transmission while reducing the DMRSs on transmission and reducing the density of the DMRSs, thereby improving the signal-to-noise ratio for signal reception and network coverage.

FIG. 6 is a flowchart of a resource mapping method for UCI according to still another embodiment of the present disclosure. This method is applied to a network device, as shown in FIG. 6, the method including the following steps.

S601, receiving, by the network device, the UCI sent on a mapped resource by a terminal device, wherein a PUCCH overlaps with a PUSCH, no DMRS is borne by a current first PUSCH, and the UCI is mapped to a PUSCH resource according to a target resource mapping mode.

In the embodiment of the present disclosure, the terminal device may detect the current channel state. If it is detected that the current channel state meets the overlap between the PUCCH and the PUSCH and no DMRS is borne on the current first PUSCH, the terminal device, in order to realize the transmission of the UCI to the network device, needs to perform resource mapping on the UCI according to the target resource mapping mode of the UCI. The target resource mapping mode is used to instruct to map the UCI to a PUSCH resource. A description of the target resource mapping mode can be referred to the description of the relevant contents in the above embodiments, and will not be repeated herein. The mapped resource is the PUSCH resource to which the UCI is mapped according to the target resource mapping mode.

Optionally, after completing the resource mapping of the UCI, the terminal device may send the UCI to the network device through the mapped resource, and accordingly, the network device may receive the UCI sent based on the mapped PUSCH resource by the terminal device.

In the resource mapping method for UCI provided by the embodiment of the present disclosure, when the terminal device determines that it is currently in a scenario where the PUCCH and the PUSCH overlap and no DMRS is borne on the current first PUSCH, the network device can receive the UCI which is sent by the terminal device through the mapped PUSCH resource. The present disclosure can not only realize the mapping of the UCI onto the PUSCH resource in the case of the absence of DMRS, but also increases the amount of data transmitted and reduces the bit rate of data transmission while reducing the DMRSs on transmission and reducing the density of the DMRSs, thereby improving the signal-to-noise ratio for signal reception and network coverage.

FIG. 7 is a flowchart of a resource mapping method for UCI according to still another embodiment of the present disclosure. This method is applied to a network device, as shown in FIG. 7, the method including the following steps.

S701, receiving, by the network device, the UCI at a position of a candidate symbol of the first PUSCH and/or a second PUSCH, wherein the second PUSCH, among PUSCHs of repeated transmissions, is adjacent to the first PUSCH and bears the DMRS.

Optionally, the terminal device may determine one or more candidate symbols from the first PUSCH and/or the second PUSCH that are suitable for mapping the UCI and map the UCI to some or all of the one or more candidate symbols.

In some implementations, the target resource mapping mode may include that the terminal device may map the UCI to a candidate symbol of the first PUSCH. In other implementations, the target resource mapping mode may include that the terminal device may map a portion of the UCI to a candidate symbol of the first PUSCH and another portion of the UCI to a candidate symbol of the second PUSCH. In yet other implementations, the target resource mapping mode may include that the terminal device may map the UCI to a candidate symbol of the second PUSCH.

Optionally, the UCI includes a Hybrid Automatic Repeat reQuest Acknowledgement (HARQ-ACK) and/or Channel State Information (CSI). In a possible implementation, the target resource mapping mode may include that the terminal device maps the HARQ-ACK to a position of a first candidate symbol of the second PUSCH; and/or, the terminal device maps the CSI to a position of a second candidate symbol of the first PUSCH.

Accordingly, the network device receives the Hybrid Automatic Repeat reQuest Acknowledgement (HARQ-ACK) at the position of the first candidate symbol of the second PUSCH; and/or, the network device receives the Channel State Information (CSI) at the position of the second candidate symbol of the first PUSCH. Optionally, the first candidate symbol is the first one on the second PUSCH that does not bear the DMRS after a target symbol, the target symbol being the earliest one that bears the DMRS. Optionally, the second candidate symbol is a symbol on the first PUSCH that is available for bearing the DMRS, or the second candidate symbol is the first one on the first PUSCH.

In the resource mapping method for UCI provided by the embodiment of the present disclosure, when the terminal device determines that it is currently in a scenario where the PUCCH and the PUSCH overlap and no DMRS is borne by the current first PUSCH, the network device can receive the UCI which is sent by the terminal device through the mapped PUSCH resource. The present disclosure can not only realize the mapping of the UCI onto the PUSCH resource in the case of the absence of DMRS, but also increases the amount of data transmitted and reduces the bit rate of data transmission while reducing the DMRSs on transmission and reducing the density of the DMRSs, thereby improving the signal-to-noise ratio for signal reception and network coverage.

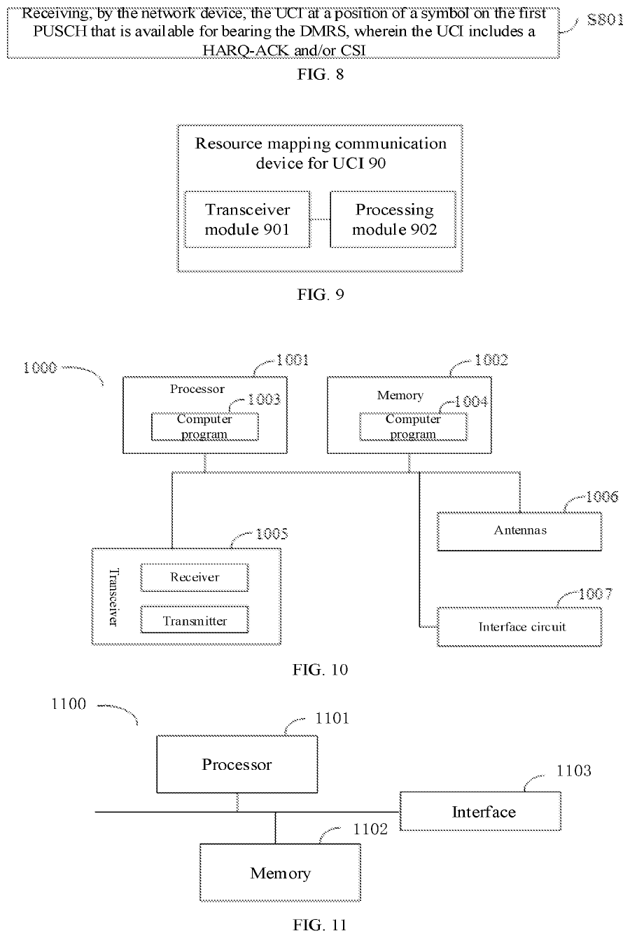

FIG. 8 is a flowchart of a resource mapping method for UCI according to still another embodiment of the present disclosure. This method is applied to a network device, as shown in FIG. 8, the method including the following steps.

S801, receiving, by the network device, the UCI at a position of a symbol on the first PUSCH that is available for bearing the DMRS, wherein the UCI includes a HARQ-ACK and/or CSI.

The terminal device may determine a symbol that can be used to bear the DMRS based on the configuration information of the symbols on the first PUSCH. Further, the terminal device may take the symbol that can be used to bear the DMRS as a candidate symbol, and map the UCI to a position of the candidate symbol on the first PUSCH, i.e., mapping the UCI to a position of the symbol that is available for bearing the DMRS on the first PUSCH.

Optionally, in response to the UCI including a HARQ-ACK, the HARQ-ACK is mapped to the first PUSCH for transmission: in response to the UCI including a HARQ-ACK and CSI, both the HARQ-ACK and the CSI may be mapped to the first PUSCH for transmission; in response to the UCI including CSI, the CSI may be mapped to the first PUSCH for transmission.

That is, the target resource mapping mode may include that the terminal device maps the HARQ-ACK and/or the CSI to the position of the symbol on the first PUSCH that is available for bearing the DMRS.

Accordingly, the network device receives the UCI at the position of the symbol on the first PUSCH that is available for bearing the DMRS.

In the resource mapping method for UCI provided by the embodiment of the present disclosure, when the terminal device determines that it is currently in a scenario where the PUCCH and the PUSCH overlap and no DMRS is borne on the current first PUSCH, the network device can receive the UCI which is sent by the terminal device through the mapped PUSCH resource. The present disclosure can not only realize the mapping of the UCI onto the PUSCH resource in the case of the absence of DMRS, but also increases the amount of data transmitted and reduces the bit rate of data transmission while reducing the DMRSs on transmission and reducing the density of the DMRSs, thereby improving the signal-to-noise ratio for signal reception and network coverage.

It should be noted that in the above embodiments of the present disclosure, the first candidate symbol of the second PUSCH and/or the second candidate symbol of the first PUSCH may be an Orthogonal Frequency Division Multiplexing (OFDM) symbol.

In the above embodiments provided by the present disclosure, the methods proposed in the embodiments of the present disclosure are described from the perspective of a network device and a terminal device, respectively. In order to realize each of the functions in the above methods provided by the embodiments of the present disclosure, the network device and the terminal device may include a hardware structure, a software module, and realize each of the functions in the form of a hardware structure, a software module, or a hardware structure combined with a software module. One of the above functions may be implemented in the form of a hardware structure, a software module, or a hardware structure combined with a software module.

According to the embodiments of the present disclosure, a communication device is further provided, which may be a terminal device (such as the terminal device in the preceding method embodiments), an apparatus in the terminal device, or an apparatus capable of being matched for use with the terminal device. Alternatively, the communication device may be a network device, or an apparatus in a network device, or an apparatus capable of being matched for use with a network device.

FIG. 9 is a schematic diagram of a structure of a communication device according to an embodiment of the present disclosure. As shown in FIG. 9, when a resource mapping communication device for UCI 90 is a terminal device, the device includes a transceiver module 901 and a processing module 902.

The transceiver module 901 is configured to determine that a physical uplink control channel (PUCCH) overlaps with a physical uplink shared channel (PUSCH) and that no demodulation reference signal (DMRS) is borne by a current first PUSCH.

The processing module 902 is configured to perform resource mapping on the UCI according to a target resource mapping mode of the UCI and send the UCI to a network device through a mapped resource, wherein the target resource mapping mode is configured to map the UCI to a PUSCH resource.

The processing module 902 is further configured to determine a second PUSCH that bears the DMRS, from PUSCHs of repeated transmissions adjacent to the first PUSCH, and map the UCI to a candidate symbol of the first PUSCH and/or the second PUSCH.

The processing module 902 is further configured to map a hybrid automatic repeat request acknowledgement (HARQ-ACK) to a position of a first candidate symbol of the second PUSCH; and/or map channel state information (CSI) to a position of a second candidate symbol of the first PUSCH.

Optionally, the first candidate symbol is the first one on the second PUSCH that does not bear the DMRS after a target symbol, the target symbol being the earliest one that bears the DMRS.

Optionally, the second candidate symbol is a symbol on the first PUSCH that is available for bearing the DMRS.

Optionally, the second candidate symbol is the first one on the first PUSCH.

Optionally, the processing module 902 is further configured to: determine a symbol on the first PUSCH that is available for bearing the DMRS; and map the UCI to a position of the symbol that is available for bearing the DMRS, wherein the UCI includes a HARQ-ACK and/or CSI.

With the communication device provided by the embodiment of the present disclosure, it can be determined that the PUCCH and the PUSCH overlap and no DMRS is borne on the current first PUSCH in the communication scenario in which it is currently located, and according to the target resource mapping mode, the UCI can be mapped to the PUSCH for transmission, which increases the amount of data transmitted and reduces the bit rate of data transmission while reducing the DMRSs on transmission and reducing the density of the DMRSs, thereby improving the signal-to-noise ratio for signal reception and network coverage.

When the communication device 90 is a network device, the device includes a receiving module (not shown) configured to receive UCI sent on a mapped resource, wherein a PUCCH overlaps with a PUSCH, no demodulation reference signal (DMRS) is borne by a current first PUSCH, and the UCI is mapped to a PUSCH resource according to a target resource mapping mode.

The receiving module is further configured to receive the UCI at a position of a candidate symbol of the first PUSCH and/or a second PUSCH, wherein the second PUSCH, among PUSCHs of repeated transmissions, is adjacent to the first PUSCH and bears the DMRS.

The receiving module is further configured to receive a hybrid automatic repeat request acknowledgement (HARQ-ACK) at a position of a first candidate symbol of the second PUSCH; and/or receive channel state information (CSI) at a position of a second candidate symbol of the first PUSCH.

Optionally, the first candidate symbol is the first one on the second PUSCH that does not bear the DMRS after a target symbol, the target symbol being the earliest one that bears the DMRS.

Optionally, the second candidate symbol is a symbol on the first PUSCH that is available for bearing the DMRS.

Optionally, the second candidate symbol is the first one on the first PUSCH.

The receiving module is further configured to receive the UCI at a position of a symbol on the first PUSCH that is available for bearing the DMRS, wherein the UCI includes a HARQ-ACK and/or CSI.

With the communication device provided by the embodiment of the present disclosure, when the terminal device determines that it is currently in a scenario where the PUCCH and the PUSCH overlap and no DMRS is borne by the current first PUSCH, the UCI can be received which is sent by the terminal device through the mapped PUSCH resource. The present disclosure can not only realize the mapping of the UCI onto the PUSCH resource in the case of the absence of DMRS, but also increases the amount of data transmitted and reduces the bit rate of data transmission while reducing the DMRSs on transmission and reducing the density of the DMRSs, thereby improving the signal-to-noise ratio for signal reception and network coverage.

FIG. 10 is a schematic diagram of a structure of another communication device 1000 provided by an embodiment of the present disclosure. The communication device 1000 may be a network device, a terminal device, a chip, a chip system, or a processor, etc. that supports the network device to implement the above methods, or may be a chip, a chip system, or a processor, etc. that supports the terminal device to implement the above methods. The device may be used to implement the method described in the above method embodiments, which can be referred to the description of the above method embodiments.

The communication device 1000 may include one or more processors 1001. The processor 1001 may be a general-purpose processor or a specialized processor, etc. For example, it may be a baseband processor or a central processor. The baseband processor may be used for processing communication protocols as well as communication data, and the central processor may be used for controlling a communication device (e.g., a base station, baseband chip, terminal device, terminal device chip, DU or CU, etc.), executing a computer program, and processing data of the computer program.

Optionally, one or more memories 1002 may also be included in the communication device 1000, on which a computer program 1004 may be stored, and the processor 1001 executes the computer program 1004 to cause the communication device 1000 to perform the method described in the above method embodiments. Optionally, the memory 1002 may also have data stored in it. The communication device 1000 and the memory 1002 may be provided separately or may be integrated together.

Optionally, the communication device 1000 may further include a transceiver 1005 and an antenna 1006. The transceiver 1005 may be referred to as a transceiver unit, a transceiver machine, or a transceiver circuit, etc., for realizing a sending and receiving function. The transceiver 1005 may include a receiver and a transmitter, the receiver may be referred to as a receiving machine or a receiving circuit, etc., for realizing the receiving function, and the transmitter may be referred to as a sending machine or a transmitting circuit, etc., for realizing the sending function.

Optionally, one or more interface circuits 1007 may also be included in the communication device 1000. The interface circuit 1007 is used to receive code instructions and transmit them to the processor 1001. The processor 1001 runs the code instructions to cause the communication device 1000 to perform the method described in the method embodiments above.

When the communication device 1000 is a terminal device, the transceiver 1005 is used to perform step S201 in FIG. 2, steps S301 and S302 in FIG. 3, steps S401 and S402 in FIG. 4, steps S501 and S502 in FIG. 5, and so on. The processor 1001 is used to perform step S202 in FIG. 2, step S303 in FIG. 3, step S403 in FIG. 4, step S503 in FIG. 5, and the like.

When the communication device 1000 is a network device, the transceiver 1005 is used to perform step S601 in FIG. 6, step S701 in FIG. 7, step S801 in FIG. 8, and so on.

In one implementation, the processor 1001 may include a transceiver for implementing the receiving and sending functions. The transceiver may be, for example, a transceiver circuit, or an interface, or an interface circuit. The transceiver circuit, the interface, or the interface circuit for realizing the receiving and sending functions may be separate or may be integrated together. The transceiver circuit, interface, or interface circuit described above may be used for code/data reading and writing, or, the transceiver circuit, interface, or interface circuit described above may be used for signal transmission or delivery.

In one implementation, the processor 1001 may have a computer program 1003 stored in it, which runs on the processor 1001 and may cause the communication device 1000 to perform the methods described in the method embodiments above. The computer program 1003 may be solidified in the processor 1001, in which case the processor 1001 may be implemented by hardware.

In one implementation, the communication device 1000 may include a circuit, and the circuit may implement the function of sending or receiving or communicating in the preceding method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, and the like. The processor and transceiver can also be manufactured using a variety of IC process technologies, such as complementary metal oxide semiconductor (CMOS), Negative channel-Metal-Oxide-Semiconductor (NMOS), positive channel metal oxide semiconductor (PMOS), bipolar junction transistor (BJT), bipolar CMOS (BiCMOS), silicon germanium (SiGe), gallium arsenide (GaAs), and so on.

The communication device in the above description of embodiments may be a network device or a terminal device (such as the terminal device in the method embodiments above), but the scope of the communication device described in the present disclosure is not limited thereto, and the structure of the communication device may not be limited by FIG. 10. The communication device may be a stand-alone device or may be part of a larger device. For example the communication device may be one of the following devices.
(1) A stand-alone integrated circuit IC, or chip, or, a system on a chip or subsystem.
(2) A collection of ICs having one or more ICs, optionally, the collection of ICs may also include storage components for storing data, computer programs.
(3) An ASIC, such as a modem.
(4) A module that can be embedded in other equipment.
(5) A receiver, terminal device, intelligent terminal device, cellular phone, wireless device, handheld, mobile unit, in-vehicle device, network device, cloud device, artificial intelligence device, and so on.
(6) Other equipment, etc.

For the case where the communication device may be a chip or a system on a chip, a schematic diagram of a structure of the chip shown in FIG. 11 can be referred to. The chip shown in FIG. 11 includes a processor 1101 and an interface 1102. There may be one or more processors 1101 and a plurality of interfaces 1102.

For the case where the chip is used to implement the functions of the terminal device in the embodiments of the present disclosure:

The interface 1102 is used to perform step S201 of FIG. 2, steps S301 and S302 of FIG. 3, steps S401 and S402 of FIG. 4, steps S501 and S502 of FIG. 5, and the like.

For the case where the chip is used to implement the functions of the network device in the embodiments of the present disclosure:

The interface 1102 is used to perform step S601 in FIG. 6, step S701 in FIG. 7, step S801 in FIG. 8, and the like.

Optionally, the chip further includes a memory 1103, the memory 1103 being used to store necessary computer programs and data.

It would also be appreciated by those skilled in the art that the various illustrative logical blocks and steps listed in the embodiments of the present disclosure can be implemented by electronic hardware, computer software, or a combination of both. Whether such functionality is implemented by hardware or software depends on the particular application and the design requirements of the overall system. Those skilled in the art may, for each particular application, use a variety of methods to implement the functionality, but such implementations should not be construed as being beyond the scope of protection of the embodiments of the present disclosure.

According to the embodiments of the present disclosure, a communication system is also provided, the system including a communication device serving as a terminal device (e.g., the terminal device in the method embodiments above) and a communication device serving as a network device in the aforementioned embodiment of FIG. 9, or, alternatively, the system including a communication device serving as a terminal device (e.g., the terminal device in the method embodiments above) and a communication device serving as a network device in the aforementioned embodiment of FIG. 10.

The present disclosure also provides a readable storage medium on which instructions are stored, and the instructions, when executed by a computer, cause the functions of any of the above method embodiments to be implemented.

The present disclosure also provides a computer program product which, when executed by a computer, causes the functions of any of the above method embodiments to be implemented.

The above embodiments may be implemented in whole or in part by software, hardware, firmware, or any combination thereof. When implemented by software, the embodiments may be implemented, in whole or in part, in the form of a computer program product. The computer program product includes one or more computer programs. When loaded and executed on a computer, the computer programs produce, in whole or in part, a process or function in accordance with embodiments of the present disclosure. The computer may be a general-purpose computer, a specialized computer, a computer network, or other programmable device. The computer program may be stored in a non-transitory computer-readable storage medium or transmitted from one computer-readable storage medium to another computer-readable storage medium, e.g., the computer program may be transmitted from a web site, computer, server, or data center via wired (e.g., coaxial cable, optical fiber, digital subscriber line (DSL)) or wireless (e.g., infrared, wireless, microwave, etc.) to another website site, computer, server, or data center. The computer-readable storage medium may be any available medium to which a computer has access or a data storage device such as a server, data center, etc. that contains one or more available medium integrated. The available medium may be a magnetic medium (e.g., a floppy disk, a hard disk, a tape), an optical medium (e.g., a high-density digital video disc (DVD)), or a semiconductor medium (e.g., a solid state disk (SSD)), among others.

A person of ordinary skill in the art may understand that the first, second and other various numerical numbers involved in the present disclosure are only for the convenience of the description of the distinction, and are not used to limit the scope of the embodiments of the present disclosure. The numerical numbers also indicate the order of precedence.

The term “at least one” in the present disclosure may also be described as “one or more”, and the term “more than one/a plurality of” may mean two, three, four, or more, without limitation in the present disclosure. In the embodiments of the present disclosure, for one type of technical feature, the technical features within that type of technical feature are distinguished by “first”, “second”, “third”, “A”, “B”, “C”, and “D”, etc. There is no sequence or order of magnitude among the technical features described by “first”, “second”, “third”, “A”, “B”, “C”, and “D”.

The correspondences shown in the tables of the present disclosure may be configured or may be predefined. The values of the information in the respective tables are merely examples and may be configured to other values, which are not limited by the present disclosure. In configuring the correspondence between the information and the respective parameters, it is not necessarily required that all the correspondences illustrated in the respective tables must be configured. For example, the correspondences illustrated in certain rows of the tables in the present disclosure may also not be configured. For example, it is possible to make appropriate adjustments based on the above tables, such as splitting, merging, and the like. The names of the parameters shown in the headings in the above-described tables may also be other names understandable by the communication device, and the values or representations of the parameters thereof may also be other values or representations understandable by the communication device. The above tables may also be realized using other data structures, such as arrays, queues, containers, stacks, linear tables, pointers, chain lists, trees, graphs, structures, classes, heaps, or hash tables, etc.

The term “predefined” in the present disclosure may be understood as defined, pre-defined, stored, pre-stored, pre-negotiated, pre-configured, cured, or pre-fired.

A person of ordinary skill in the art may realize that the units and algorithmic steps of the various examples described in conjunction with the embodiments disclosed herein are capable of being implemented in electronic hardware, or a combination of computer software and electronic hardware. Whether these functions are performed in hardware or software depends on the particular application and design constraints of the technical solution. A person skilled in the art may use different methods to implement the described functions for each particular application, but such implementations should not be considered beyond the scope of the present disclosure

It is clearly understood by those skilled in the art that, for the convenience and brevity of the description, the specific working processes of the above-described systems, apparatuses, and units can be referred to the corresponding processes in the foregoing embodiments of the method, and will not be repeated herein.

The above are only specific embodiments of the present disclosure, but the scope of protection of the present disclosure is not limited thereto, and any skilled person familiar with the technical field can easily expect variations or substitutions within the scope of the technology disclosed in the present disclosure, which shall be covered by the scope of protection of the present disclosure. Therefore, the scope of protection of the present disclosure shall be subject to the scope of protection of the claims.

Obviously, numerous modifications and variations of the present invention are possible in light of the above teachings. It is therefore to be understood that within the scope of the appended claims, the invention may be practiced otherwise than as specifically described herein.

1. A resource mapping method for uplink control information (UCI) comprising:
determining, by a terminal device, that a Physical Uplink Control Channel (PUCCH) overlaps with a Physical Uplink Shared Channel (PUSCH) and that no Demodulation Reference Signal (DMRS) is borne by a current first PUSCH;
performing, by the terminal device, resource mapping on the UCI according to a target resource mapping mode of the UCI, wherein the target resource mapping mode is configured to map the UCI to a PUSCH resource; and
sending, by the terminal device, the UCI to a network device through the mapped resource.

2. The method of claim 1, wherein performing resource mapping on the UCI according to the target resource mapping mode of the UCI, comprises:
determining, by the terminal device, a second PUSCH that bears the DMRS, from PUSCHs of repeated transmissions adjacent to the first PUSCH; and
mapping, by the terminal device, the UCI to a candidate symbol of at least one of the first PUSCH and the second PUSCH.

3. The method of claim 2, wherein mapping the UCI to the candidate symbol of at least one of the first PUSCH and the second PUSCH, comprises:
mapping, by the terminal device, a Hybrid Automatic Repeat reQuest Acknowledgement (HARQ-ACK) to a position of a first candidate symbol of the second PUSCH; and/or
mapping, by the terminal device, Channel State Information (CSI) to a position of a second candidate symbol of the first PUSCH.

4. The method of claim 3, wherein the first candidate symbol is the first one on the second PUSCH that does not bear the DMRS after a target symbol, the target symbol being the earliest one that bears the DMRS.

5. The method of claim 3, wherein the second candidate symbol is a symbol on the first PUSCH that is available for bearing the DMRS.

6. The method of claim 3, wherein the second candidate symbol is the first one on the first PUSCH.

7. The method of claim 1, wherein performing resource mapping on the UCI according to the target resource mapping mode of the UCI, comprises:
determining, by the terminal device, a symbol on the first PUSCH that is available for bearing the DMRS; and
mapping, by the terminal device, the UCI to a position of the symbol that is available for bearing the DMRS, wherein the UCI comprises at least one of a HARQ-ACK and CSI.

8. A resource mapping method for uplink control information (UCI) comprising:
receiving, by a network device, the UCI sent on a mapped resource by a terminal device, wherein a Physical Uplink Control Channel (PUCCH) overlaps with a Physical Uplink Shared Channel (PUSCH), no Demodulation Reference Signal (DMRS) is borne by a current first PUSCH, and the UCI is mapped to a PUSCH resource according to a target resource mapping mode.

9. The method of claim 8, further comprising:
receiving, by the network device, the UCI at a position of a candidate symbol of at least one of the first PUSCH and a second PUSCH, wherein the second PUSCH, among PUSCHs of repeated transmissions, is adjacent to the first PUSCH and bears the DMRS.

10. The method of claim 9, further comprising:
receiving, by the network device, a Hybrid Automatic Repeat reQuest Acknowledgement (HARQ-ACK) at a position of a first candidate symbol of the second PUSCH; and/or
receiving, by the network device, Channel State Information (CSI) at a position of a second candidate symbol of the first PUSCH.

11. The method of claim 10, wherein the first candidate symbol is the first one on the second PUSCH that does not bear the DMRS after a target symbol, the target symbol being the earliest one that bears the DMRS.

12. The method of claim 10, wherein the second candidate symbol is a symbol on the first PUSCH that is available for bearing the DMRS.

13. The method of claim 10, wherein the second candidate symbol is the first one on the first PUSCH.

14. The method of claim 9, further comprising:
receiving, by the network device, the UCI at a position of a symbol on the first PUSCH that is available for bearing the DMRS, wherein the UCI comprises at least one of a HARQ-ACK and CSI.

15-28. (Canceled)

29. A communication device, comprising a processor and a memory, the memory having a computer program stored therein, the processor executing the computer program stored in the memory to cause the device to:
determine that a Physical Uplink Control Channel (PUCCH) overlaps with a Physical Uplink Shared Channel (PUSCH) and that no Demodulation Reference Signal (DMRS) is borne by a current first PUSCH;
perform resource mapping on the UCI according to a target resource mapping mode of the UCI, wherein the target resource mapping mode is configured to map the UCI to a PUSCH resource; and
send the UCI to a network device through the mapped resource.

30. A communication device, comprising a processor and a memory, the memory having a computer program stored therein, the processor executing the computer program stored in the memory to cause the device to perform the method of claim 8.

31. A communication device, comprising: a processor and an interface circuit, wherein
the interface circuit is configured to receive code instructions and transmit the code instructions to the processor; and
the processor is configured to run the code instructions to perform the method of claim 1.

32. A communication device, comprising: a processor and an interface circuit, wherein
the interface circuit is configured to receive code instructions and transmit the code instructions to the processor; and
the processor is configured to run the code instructions to perform the method of claim 8.

33. A non-transitory computer-readable storage medium configured to store instructions which, when executed, cause the method of claim 1 to be implemented.

34. A non-transitory computer-readable storage medium configured to store instructions which, when executed, cause the method of claim 8 to be implemented.
